(19) United States
(12) Patent Application Publication
(10) Pub. No.: US 2024/0054519 A1
(43) Pub. Date: Feb. 15, 2024

(54) SYSTEMS AND METHODS OF PROVISIONING A REBATE BASED ON PURCHASING

(71) Applicant: Jason Oliver Silva, New Bedford, MA (US)

(72) Inventor: Jason Oliver Silva, New Bedford, MA (US)

(21) Appl. No.: 17/976,802

(22) Filed: Oct. 30, 2022

Related U.S. Application Data
(60) Provisional application No. 63/396,588, filed on Aug. 9, 2022.

(51) Int. Cl. G06Q 30/02; G06Q 30/06; G06Q 10/08

(52) U.S. Cl. CPC G06Q 30/0215; G06Q 30/0222; G06Q 30/0635; G06Q 10/083

(57) ABSTRACT

The present disclosure provides a method of provisioning a rebate based on purchasing. Further, the method may include receiving, using a communication device, a transaction information from a merchant device associated with a merchant, wherein the transaction information may comprise a user information associated with a user and a delivery mode information associated with a purchase request corresponding to a product. Further, the method may include identifying, using a processing device, a user account associated with the user based on the user information. Further, the method may include crediting, using the processing device, a rebate amount to the user account based on the identifying and the delivery mode information, wherein the user account is stored on a distributed ledger. Further, the method may include storing, using a storage device, the rebate amount in the distributed ledger.

### CROSS-REFERENCE TO RELATED APPLICATIONS

This application claims the benefit of U.S. Provisional Application No. 63/396,588 filed on 9 Aug. 2022, the contents of which are hereby incorporated by reference.

### FIELD OF DISCLOSURE

The present disclosure generally relates to data processing systems or methods, specially adapted for administrative, commercial, financial, managerial, supervisory, or forecasting purposes. More specifically, the present disclosure relates to systems and methods of provisioning a rebate based on purchasing.

### BACKGROUND

The field of data processing is technologically important to several industries, business organizations, and/or individuals.

Existing techniques for provisioning a rebate based on purchasing are deficient in several ways. Further, current techniques are not specifically designed for providing an option for payment by rebate amount. As a result, different techniques are needed for providing the option for payment by rebate amount. Further, the current techniques are not specifically designed for receiving the rebate for delivery and curbside pickup of the product. As a result, different techniques are needed for receiving the rebate for delivery and curbside pickup of the product. Furthermore, current techniques are not specifically designed for maintaining the rebate account of the customer by the merchant. As a result, different techniques are needed for maintaining the rebate account of the customer by the merchant.

Therefore, there is a need for improved systems and methods of provisioning a rebate based on purchasing that may overcome one or more of the above-mentioned problems and/or limitations.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method of provisioning a rebate based on purchasing. Further, the method may include receiving, using a communication device, a transaction information from a merchant device associated with a merchant. Further, the transaction information may comprise a user information associated with a user and a delivery mode information associated with a purchase request corresponding to a product. Further, the method may include identifying, using a processing device, a user account associated with the user based on the user information. Further, the method may include crediting, using the processing device, a rebate amount to the user account based on the identifying and the delivery mode information. Further, the user account may be stored on a distributed ledger. Further, the method may include storing, using a storage device, the rebate amount in the distributed ledger.

The present disclosure provides a system of provisioning a rebate based on purchasing. Further, the system may include a communication device which may be configured for receiving a transaction information from a merchant device associated with a merchant. Further, the transaction information may comprise a user information associated with a user and a delivery mode information associated with a purchase request corresponding to a product. Further, the system may include a processing device. Further, the processing device may be configured for identifying a user account associated with the user based on the user information. Further, the user account may be stored on a distributed ledger. Further, the processing device may be configured for crediting a rebate amount to the user account based on the identifying and the delivery mode information. Further, the system may include a storage device which may be configured for storing the rebate amount in the distributed ledger.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 illustrates a flowchart of a method 300 of provisioning a rebate based on purchasing, in accordance with some embodiments.

FIG. 4 illustrates a flowchart of a method 400 of provisioning a rebate based on purchasing, in accordance with some embodiments.

FIG. 5 illustrates a flowchart of a method 500 of provisioning a rebate based on purchasing, in accordance with some embodiments.

FIG. 6 illustrates a flowchart of a method 600 of provisioning a rebate based on purchasing, in accordance with some embodiments.

FIG. 7 illustrates a flowchart of a method 700 of provisioning a rebate based on purchasing, in accordance with some embodiments.

FIG. 8 illustrates a flowchart of a method 800 of provisioning a rebate based on purchasing, in accordance with some embodiments.

FIG. 9 illustrates a flowchart of a method 900 of provisioning a rebate based on purchasing, in accordance with some embodiments.

FIG. 10 illustrates a flowchart of a method 1000 of provisioning a rebate based on purchasing, in accordance with some embodiments.

FIG. 11 illustrates a flowchart of a method 1100 of provisioning a rebate based on purchasing, in accordance with some embodiments.

FIG. 12 illustrates a flowchart of a method 1200 of provisioning a rebate based on purchasing, in accordance with some embodiments.

FIG. 13 illustrates a block diagram of a system 1300 of provisioning a rebate based on purchasing, in accordance with some embodiments.

FIG. 14 illustrates a block diagram of the system 1300 of provisioning a rebate based on purchasing, in accordance with some embodiments.

FIG. 15 is a flowchart of a method 1500 for facilitating provisioning rebates based on purchasing, in accordance with some embodiments.

FIG. 16 is a flowchart of a method 1600 for facilitating transmitting transactions associated with the at least one user, in accordance with some embodiments.

FIG. 17 is a flowchart of a method 1700 facilitating transferring rebate amount to the at least one user, in accordance with some embodiments.

FIG. 18 is a flowchart of a method 1800 for facilitating accumulating rebates with purchases, in accordance with some embodiments.

FIG. 19 is a flowchart of a method 1900 for facilitating applying the rebate for purchasing, in accordance with some embodiments.

FIG. 20 is a flowchart of a method 2000 for facilitating transferring rebate funds to the customer, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of facilitating provisioning a rebate based on purchasing, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g., Windows, Mac OS, Unix, Linux, Android, etc.) in order to provide a user interface (e.g., GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g., transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g., initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes methods and systems of facilitating provisioning a rebate based on purchasing. Further, the disclosed system may include a delivery/curbside rebate rewards system. Further, the disclosed system may allow a customer to purchase one or more rebate-eligible products online. Further, the customer may choose the delivery or a curbside pickup at checkout. Further, the rebate may be ineligible for not choosing the delivery and the curbside pickup as an option. Further, the disclosed system may be configured for the processing of a transaction. Further, the customer may be charged for at least one product, at least one tax, and at least one delivery fee. Further, the delivery and the curbside pickup may be executed. Further, a rebate amount may be credited into a customer rebate account with a merchant based on confirmation of the rebate. Further, the customer may accumulate the rebate with all qualifying transactions over a given period at the discretion of the merchant. Further, the rebate may be sent to the customer through a bank wire, or a check (cheque). Further, the rebate may be used to discount future purchases at the discretion of the merchant. Further, the rebate may be specifically designed for a retailer and a gig economy business for executing the delivery and the curbside pickup of the one or more rebate-eligible products of the customer. Further, shipping and in-store purchase may be ineligible for the rebate. Further, the transaction may be placed at a website of the merchant and the rebate banks may be held within the customer account associated with each customer with the merchant. Further, the rebate may be sent to the customer via bank wire, check, or discount on future orders at the discretion of the merchant. Further, the disclosed method may be executed by an inventive server.

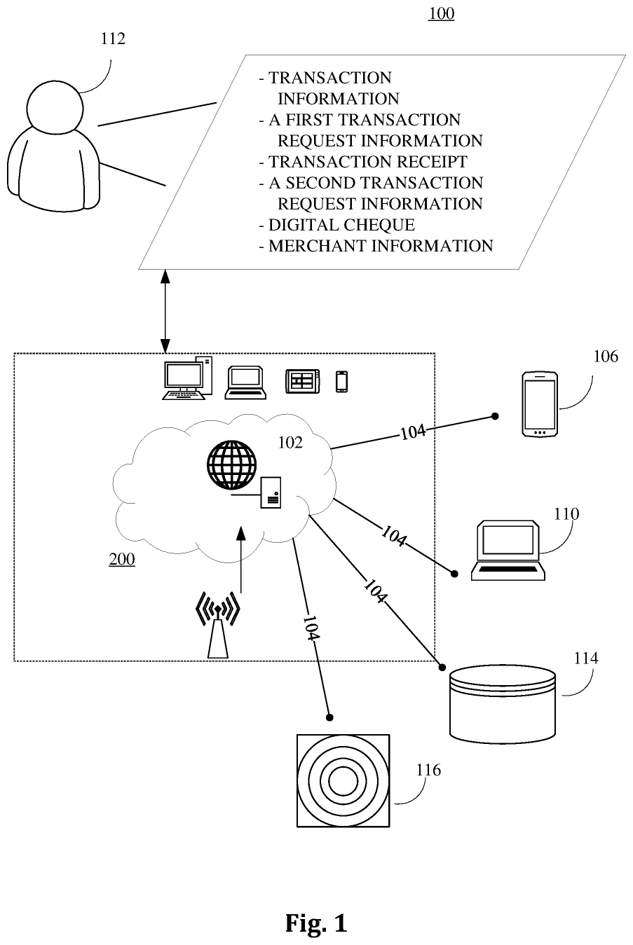

FIG. 1 is an illustration of an online platform 100 consistent with various embodiments of the present disclosure. By way of non-limiting example, the online platform 100 to enable facilitating provisioning a rebate based on purchasing may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

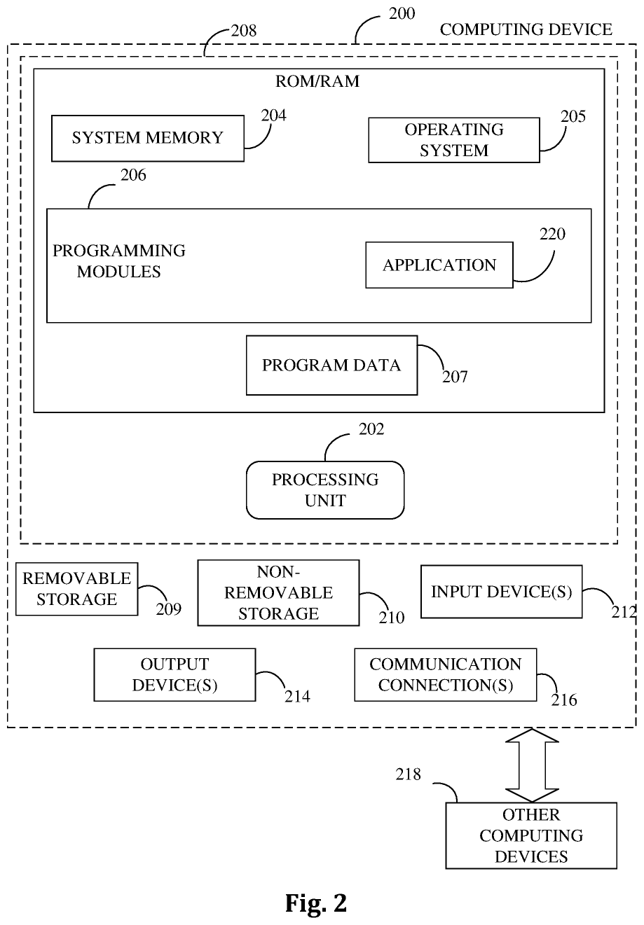

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g., random-access memory (RAM)), non-volatile (e.g., read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

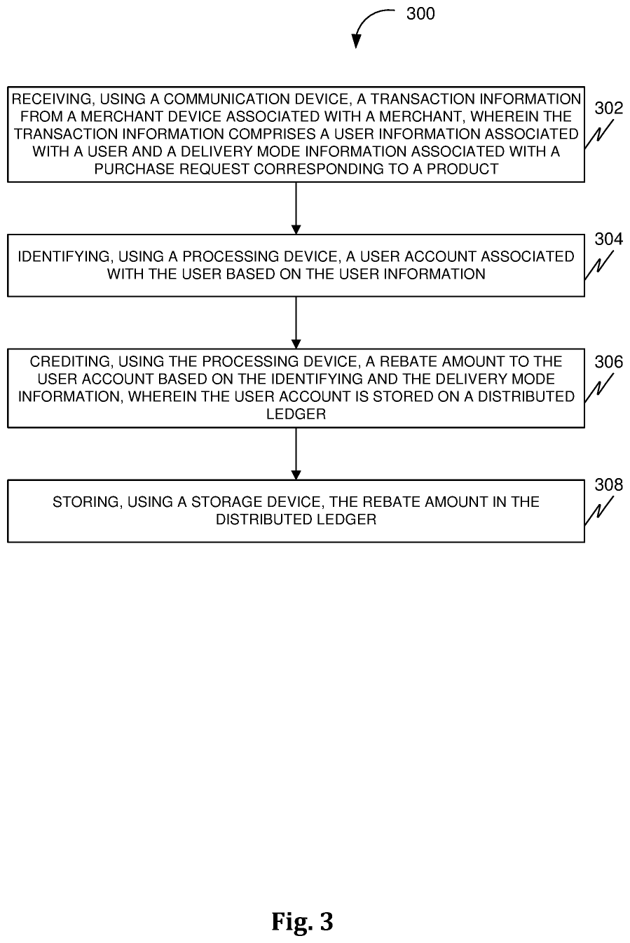

FIG. 3 illustrates a flowchart of a method 300 of provisioning a rebate based on purchasing, in accordance with some embodiments.

Accordingly, the method 300 may include a step 302 of receiving, using a communication device 1302, a transaction information from a merchant device (such as a merchant device 1402) associated with a merchant. Further, the transaction information may comprise a user information associated with a user and a delivery mode information associated with a purchase request corresponding to a product. Further, the transaction information may include a merchant name, a merchant online website, etc. Further, the merchant device may refer to, for example, an online server hosting an e-commerce store through which the user makes the purchase. In another example, the merchant device may include a POS terminal. In yet another instance, the merchant device may include any computing device operable by a user such as a desktop computer, a laptop computer, a smartphone, and a wearable computer. Further, in an instance, the deliver mode information indicates a type of delivery associated with the product. For example, the type of delivery may be a curb-side pickup.

Further, the method 300 may include a step 304 of identifying, using a processing device 1304, a user account associated with the user based on the user information.

Further, the method 300 may include a step 306 of crediting, using the processing device 1304, a rebate amount to the user account based on the identifying and the delivery mode information, wherein the user account is stored on a distributed ledger.

Further, the method 300 may include a step 308 of storing, using a storage device 1306, the rebate amount in the distributed ledger.

Further, in some embodiments, the method 300 may be executed by an inventive server. Further, the method 300 may include providing the rebate amount to a customer for purchasing a product with a curb pickup delivery method.

Further, in some embodiments, the method 300 further include a step of receiving, using the communication device 1302, a confirmation information from the merchant device. Further, the confirmation information may indicate receipt of the product according to the delivery mode information. Further, the crediting may be based on the confirmation information. Accordingly, in an instance, the rebate amount may be credited to the user account only when the product is received by the user in accordance with the delivery mode information. For example, if the delivery mode information indicates a curbside pickup, the confirmation information may indicate actual performance of the curbside pickup by the user. Accordingly, the rebate amount may be credited to the user account based on the actual performance of the curbside pickup.

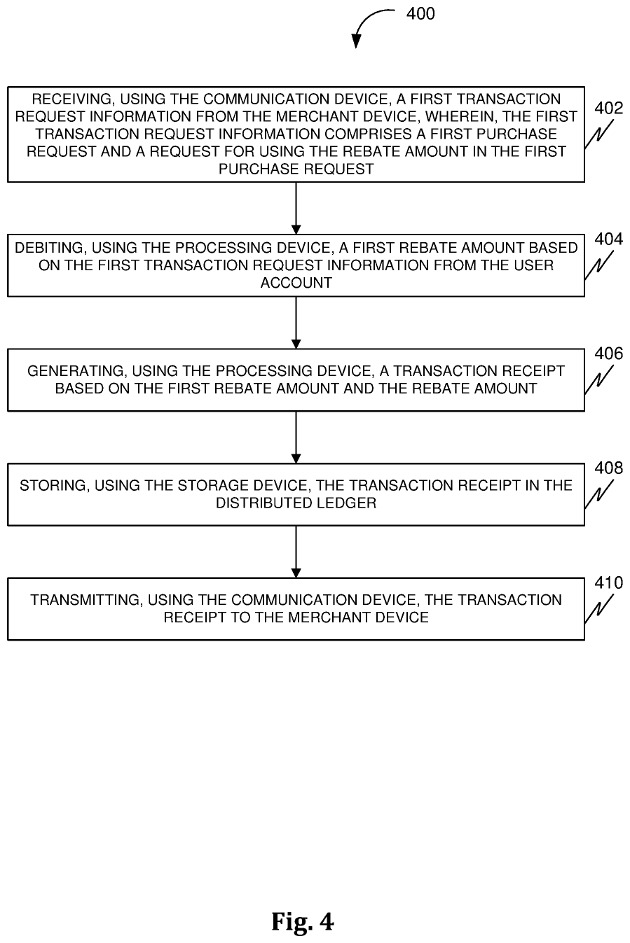

FIG. 4 illustrates a flowchart of a method 400 of provisioning a rebate based on purchasing, in accordance with some embodiments. Accordingly, the method 400 may include using the rebate amount as a discount while purchasing the product.

Further, the method 400 may include a step 402 of receiving, using the communication device 1302, a first transaction request information from the merchant device. Further, the first transaction request information may comprise a first purchase request and a request for using the rebate amount in the first purchase request. Further, the first transaction request information may include a request for using rebate amount as a discount while purchasing the product.

Further, the method 400 may include a step 404 of debiting, using the processing device 1304, a first rebate amount based on the first transaction request information from the user account. Further, the first rebate amount may be a portion of the rebate amount stored in the user account.

Further, the method 400 may include a step 406 of generating, using the processing device 1304, a transaction receipt based on the first rebate amount and the rebate amount.

Further, the method 400 may include a step 408 of storing, using the storage device 1306, the transaction receipt in the distributed ledger.

Further, the method 400 may include a step 410 of transmitting, using the communication device 1302, the transaction receipt to the merchant device.

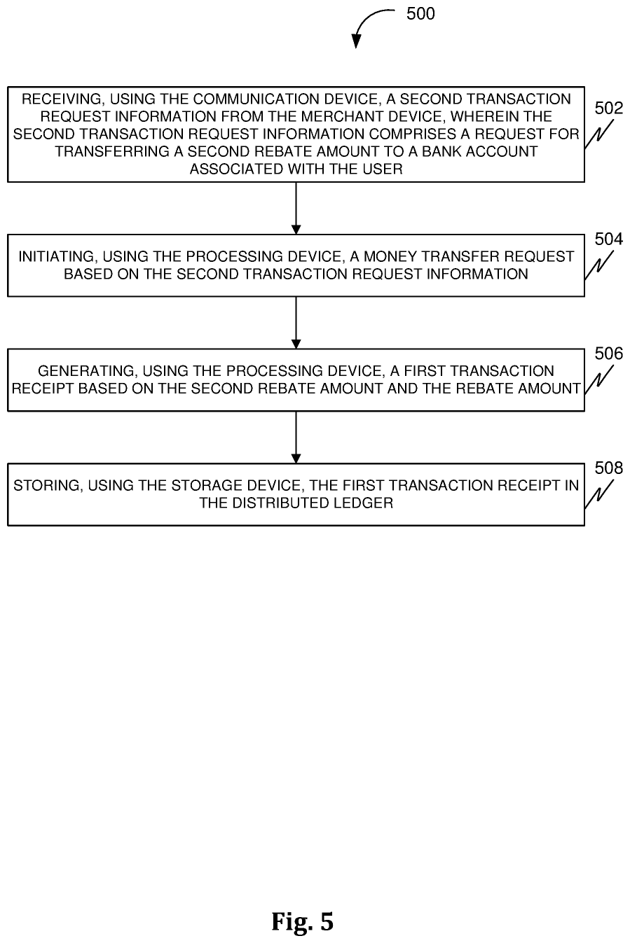

FIG. 5 illustrates a flowchart of a method 500 of provisioning a rebate based on purchasing, in accordance with some embodiments. Accordingly, the method 500 may include sending (or transmitting) the rebate amount via wire to a bank account of a customer (or a user).

Further, the method 500 may include a step 502 of receiving, using the communication device 1302, a second transaction request information from the merchant device. Further, the second transaction request information may comprise a request for transferring a second rebate amount to a bank account associated with the user. Further, the second rebate amount may be a portion of the rebate amount stored in the user device.

Further, the method 500 may include a step 504 of initiating, using the processing device 1304, a money transfer request based on the second transaction request information.

Further, the method 500 may include a step 506 of generating, using the processing device 1304, a first transaction receipt based on the second rebate amount and the rebate amount.

Further, the method 500 may include a step 508 of storing, using the storage device 1306, the first transaction receipt in the distributed ledger.

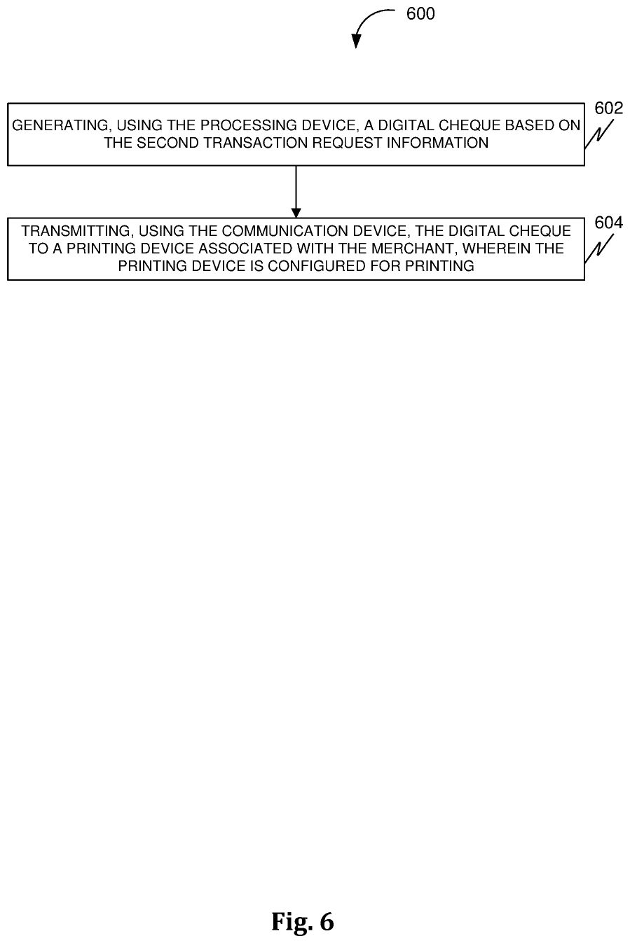

FIG. 6 illustrates a flowchart of a method 600 of provisioning a rebate based on purchasing, in accordance with some embodiments. Accordingly, the method 600 may include transferring the rebate amount using a cheque.

Further, the method 600 may include a step 602 of generating, using the processing device 1304, a digital cheque based on the second transaction request information.

Further, the method 600 may include a step 604 of transmitting, using the communication device 1302, the digital cheque to a printing device (such as a printing device 1404) associated with the merchant, wherein the printing device may be configured for printing.

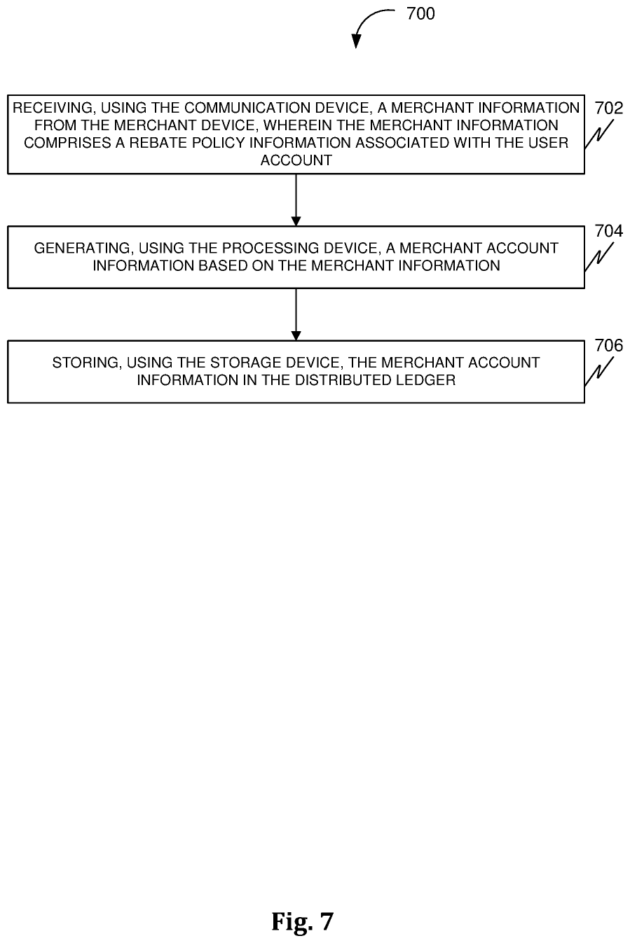

FIG. 7 illustrates a flowchart of a method 700 of provisioning a rebate based on purchasing, in accordance with some embodiments. Accordingly, the method 700 may include using the rebate amount as a discount while purchasing the product.

Further, the method 700 may include a step 702 of receiving, using the communication device 1302, a merchant information from the merchant device. Further, the merchant information may comprise a rebate policy information associated with the user account. Further, the merchant information may include a merchant name, a merchant online website, a merchant bank account details, etc.

Further, the method 700 may include a step 704 of generating, using the processing device 1304, a merchant account information based on the merchant information. Further, the merchant account information may include login id and password.

Further, the method 700 may include a step 706 of storing, using the storage device 1306, the merchant account information in the distributed ledger.

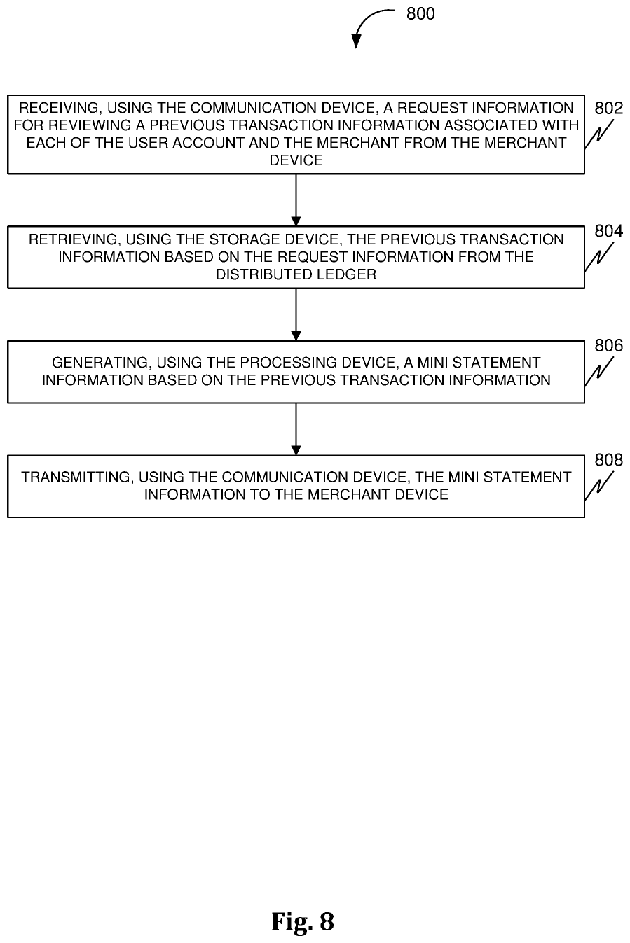

FIG. 8 illustrates a flowchart of a method 800 of provisioning a rebate based on purchasing, in accordance with some embodiments. Accordingly, the method 800 may include checking a rebate balance.

Further, the method 800 may include a step 802 of receiving, using the communication device 1302, a request information for reviewing a previous transaction information associated with each of the user account and the merchant from the merchant device. Further, the previous transaction information may include previous transactions associated with the user account. Further, the previous transaction information may include an information about the previous transactions, current rebate balance, etc.

Further, the method 800 may include a step 804 of retrieving, using the storage device 1306, the previous transaction information based on the request information from the distributed ledger.

Further, the method 800 may include a step 806 of generating, using the processing device 1304, a mini statement information based on the previous transaction information. Further, the mini statement information may include a customer information, an information of the previous transaction, a current rebate balance, etc.

Further, the method 800 may include a step 808 of transmitting, using the communication device 1302, the mini statement information to the merchant device.

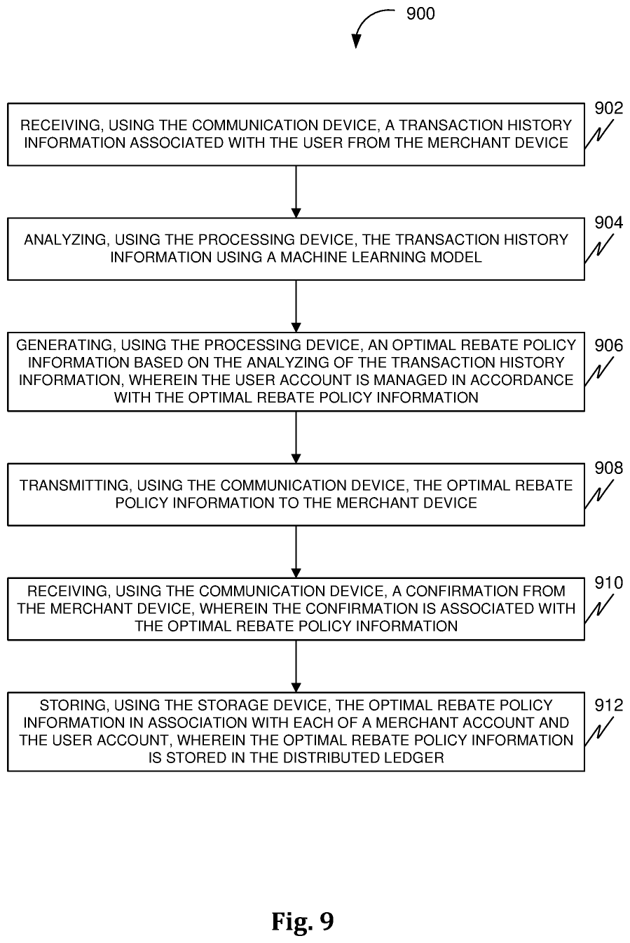

FIG. 9 illustrates a flowchart of a method 900 of provisioning a rebate based on purchasing, in accordance with some embodiments.

Further, the method 900 may include a step 902 of receiving, using the communication device 1302, a transaction history information associated with the user from the merchant device.

Further, the method 900 may include a step 904 of analyzing, using the processing device 1304, the transaction history information using a machine learning model.

Further, the method 900 may include a step 906 of generating, using the processing device 1304, an optimal rebate policy information based on the analyzing of the transaction history information. Further, the user account may be managed in accordance with the optimal rebate policy information.

Further, the method 900 may include a step 908 of transmitting, using the communication device 1302, the optimal rebate policy information to the merchant device.

Further, the method 900 may include a step 910 of receiving, using the communication device 1302, a confirmation from the merchant device. Further, the confirmation may be associated with the optimal rebate policy information.

Further, the method 900 may include a step 912 of storing, using the storage device 1306, the optimal rebate policy information in association with each of a merchant account and the user account. Further, the optimal rebate policy information may be stored in the distributed ledger.

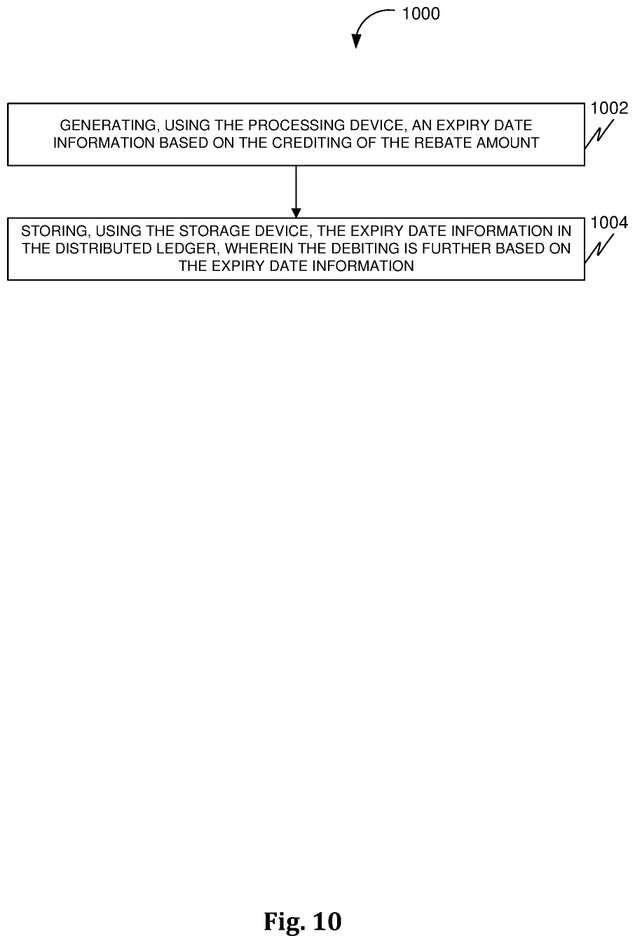

FIG. 10 illustrates a flowchart of a method 1000 of provisioning a rebate based on purchasing, in accordance with some embodiments. Accordingly, the method 1000 may include setting up an expiry date for the rebate amount if not used.

Further, the method 1000 may include a step 1002 of generating, using the processing device 1304, an expiry date information based on the crediting of the rebate amount. Further, the expiry date information may include a date, a time, a rebate amount, etc.

Further, the method 1000 may include a step 1004 of storing, using the storage device 1306, the expiry date information in the distributed ledger. Further, the debiting may be based on the expiry date information.

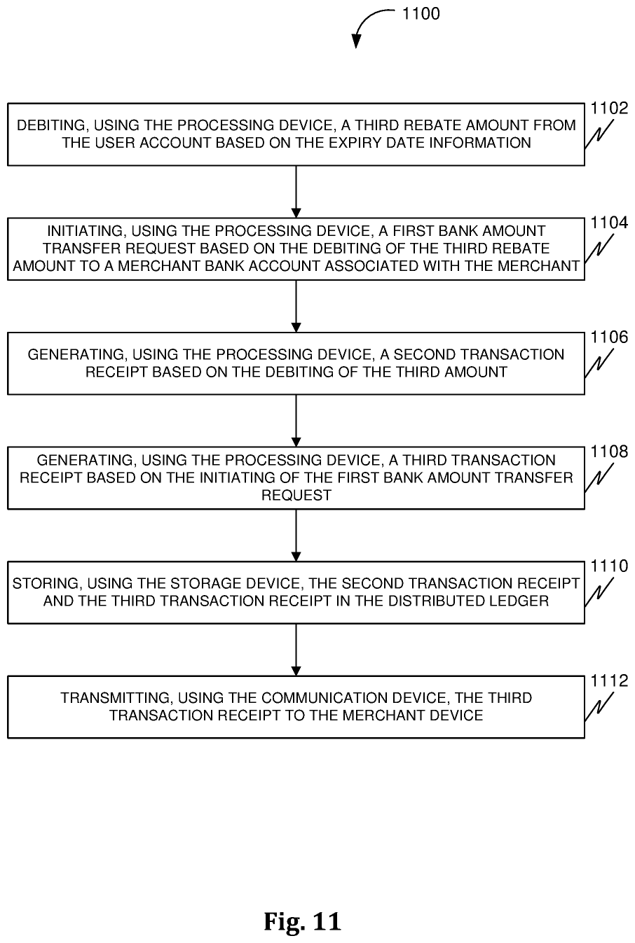

FIG. 11 illustrates a flowchart of a method 1100 of provisioning a rebate based on purchasing, in accordance with some embodiments.

Further, the method 1100 may include a step 1102 of debiting, using the processing device 1304, a third rebate amount from the user account based on the expiry date information. Further, the third rebate amount may be an amount that got expired and further may be debited from the user account and transferred to the merchant account.

Further, the method 1100 may include a step 1104 of initiating, using the processing device 1304, a first bank amount transfer request based on the debiting of the third rebate amount to a merchant bank account associated with the merchant.

Further, the method 1100 may include a step 1106 of generating, using the processing device 1304, a second transaction receipt based on the debiting of the third rebate amount.

Further, the method 1100 may include a step 1108 of generating, using the processing device 1304, a third transaction receipt based on the initiating of the first bank amount transfer request.

Further, the method 1100 may include a step 1110 of storing, using the storage device 1306, the second transaction receipt and the third transaction receipt in the distributed ledger.

Further, the method 1100 may include a step 1112 of transmitting, using the communication device 1302, the third transaction receipt to the merchant device.

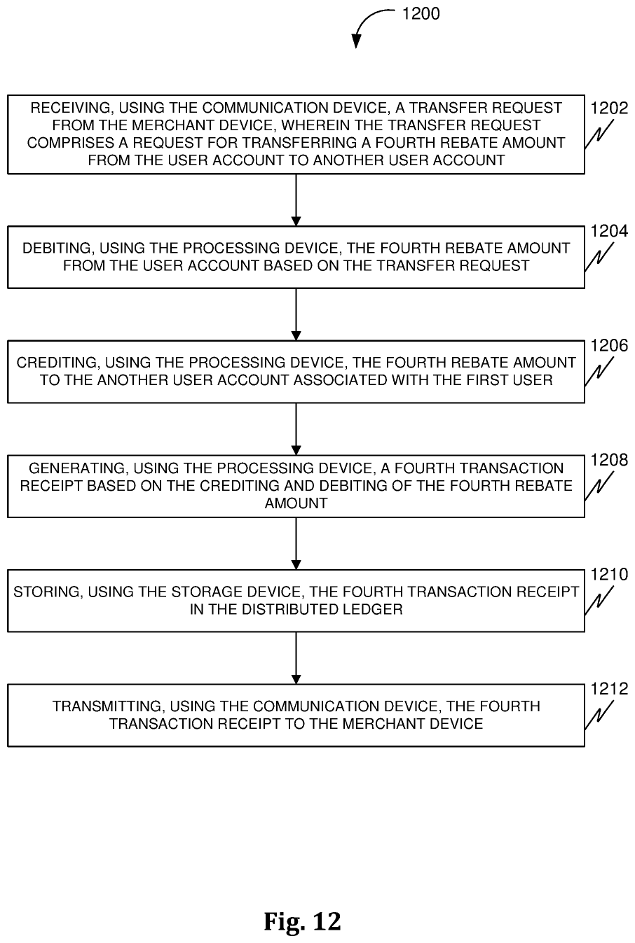

FIG. 12 illustrates a flowchart of a method 1200 of provisioning a rebate based on purchasing, in accordance with some embodiments. Accordingly, the method 1100 may include transferring the rebate amount to other rebate account.

Further, the method 1200 may include a step 1202 of receiving, using the communication device 1302, a transfer request from the merchant device. Further, the transfer request may comprise a request for transferring a fourth rebate amount from the user account to another user account. Further, the transfer request may include at least one request for transferring the rebate amount, a rebate amount that needs to be transferred, a customer detail, etc.

Further, the method 1200 may include a step 1204 of debiting, using the processing device 1304, the fourth rebate amount from the user account based on the transfer request.

Further, the method 1200 may include a step 1206 of crediting, using the processing device 1304, the fourth rebate amount to the another user account associated with another user.

Further, the method 1200 may include a step 1208 of generating, using the processing device 1304, a fourth transaction receipt based on the crediting and debiting of the fourth rebate amount.

Further, the method 1200 may include a step 1210 of storing, using the storage device 1306, the fourth transaction receipt in the distributed ledger.

Further, the method 1200 may include a step 1212 of transmitting, using the communication device 1302, the fourth transaction receipt to the merchant device.

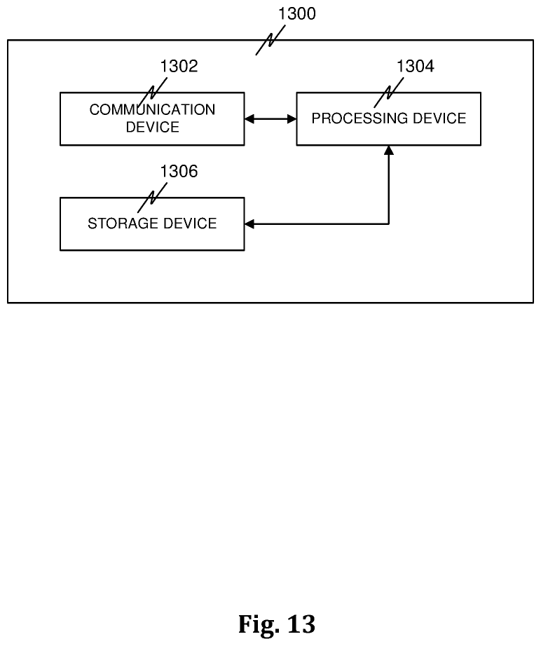

FIG. 13 illustrates a block diagram of a system 1300 of provisioning a rebate based on purchasing, in accordance with some embodiments.

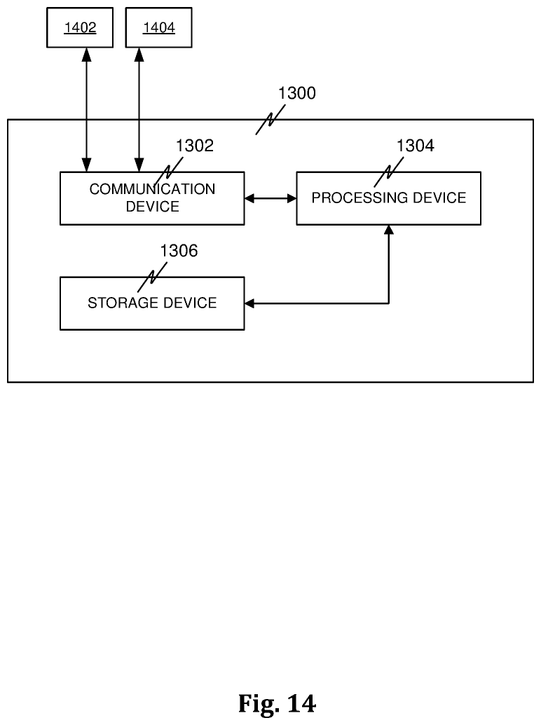

Accordingly, the system 1300 may include a communication device 1302 which may be configured for receiving a transaction information from a merchant device 1402 (as shown in FIG. 14) associated with a merchant. Further, the transaction information may comprise a user information associated with a user and a delivery mode information associated with a purchase request corresponding to a product.

Further, the system 1300 may include a processing device 1304. Further, the processing device 1304 may be configured for identifying a user account associated with the user based on the user information. Further, the user account may be stored on a distributed ledger. Further, the processing device 1304 may be configured for crediting a rebate amount to the user account based on the identifying and the delivery mode information. Further, the system 1300 may include a storage device 1306 which may be configured for storing the rebate amount in the distributed ledger.

Further, in some embodiments, the communication device 1302 may be configured for receiving a first transaction request information from the merchant device 1402, wherein the first transaction request information may comprise a first purchase request and a request for using the rebate amount in the first purchase request. Further, the communication device 1302 may be configured for transmitting a transaction receipt to the merchant device 1402. Further, the processing device 1304 may be configured for debiting a first rebate amount based on the first transaction request information from the user account. Further, the processing device 1304 may be configured for generating the transaction receipt based on the first rebate amount and the rebate amount. Further, the storage device 1306 may be configured for storing the transaction receipt in the distributed ledger.

Further, in some embodiments, the communication device 1302 may be configured for receiving a second transaction request information from the merchant device 1402. Further, the second transaction request information may include a request for transferring a second rebate amount to a bank account associated with the user. Further, the processing device 1304 may be configured for initiating a money transfer request based on the second transaction request information. Further, the processing device 1304 may be configured for generating a first transaction receipt based on the second rebate amount and the rebate amount. Further, the storage device 1306 may be configured for storing the first transaction receipt in the distributed ledger.

In some embodiments, the communication device 1302 may be configured for transmitting a digital cheque to a printing device 1404 (as shown in FIG. 14) associated with the merchant, wherein the printing device 1404 may be configured for printing. Further, the processing device 1304 may be configured for generating the digital cheque based on the second transaction request information.

In some embodiments, the communication device 1302 may be configured for receiving a merchant information from the merchant device 1402. Further, the merchant information may comprise a rebate policy information associated with the user account. Further, the processing device 1304 may be configured for generating a merchant account information based on the merchant information; and the storing device 1306 may be configured for storing the merchant account information in the distributed ledger.

Further, in some embodiments, the communication device 1302 may be configured for receiving a request information for reviewing a previous transaction information associated with each of the user account and the merchant from the merchant device 1402. Further, the communication device 1302 may be configured for transmitting a mini statement information to the merchant device 1402. Further, the storage device 1306 may be configured for retrieving the previous transaction information based on the request information for reviewing the previous transaction information associated with the user account from the distributed ledger. Further, the processing device 1304 may be configured for generating the mini statement information based on the previous transaction information.

Further, in some embodiments, the communication device 1302 may be configured for receiving a transaction history information associated with the user from the merchant device 1402. Further, the communication device 1302 may be configured for transmitting an optimal rebate policy information to the merchant device 1402. Further, the communication device 1302 may be configured for receiving a confirmation from the merchant device 1402. Further, the confirmation may be associated with the optimal rebate policy information. Further, the processing device 1304 may be configured for analyzing the transaction history information using a machine learning model. Further, the processing device 1304 may be configured for generating the optimal rebate policy information based on the analyzing of the transaction history information. Further, the user account may be managed in accordance with the optimal rebate policy information. Further, the storage device 1306 may be configured for storing the optimal rebate policy information in association with each of a merchant account and the user account. Further, the optimal rebate policy information may be stored in the distributed ledger.

In some embodiments, the processing device 1304 may be configured for generating an expiry date information based on the crediting of the rebate amount. Further, the storage device 1306 may be configured for storing the expiry date information in the distributed ledger. Further, the debiting may be based on the expiry date information.

Further, in some embodiments, the communication device 1302 may be configured for transmitting a third transaction receipt to the merchant device 1402. Further, the processing device 1304 may be configured for debiting a third rebate amount from the user account based on the expiry date information. Further, the processing device 1304 may be configured for initiating a first bank amount transfer request based on the debiting of the third rebate amount to a merchant bank account associated with the merchant. Further, the processing device 1304 may be configured for generating a second transaction receipt based on the debiting of the third rebate amount. Further, the processing device 1304 may be configured for generating the third transaction receipt based on the initiating of the first bank amount transfer request. Further, the storage device 1306 may be configured for storing the second transaction receipt and the third transaction receipt in the distributed ledger

Further, in some embodiments, the communication device 1302 may be configured for receiving a transfer request from the merchant device 1402. Further, the transfer request may comprise a request for transferring a fourth rebate amount from the user account to another user account. Further, the communication device 1302 may be configured for transmitting a fourth transaction receipt to the merchant device 1402. Further, the processing device 1304 may be configured for debiting the fourth rebate amount from the user account based on the transfer request. Further, the processing device 1304 may be configured for crediting the fourth rebate amount to the another user account associated with another user. Further, the processing device 1304 may be configured for generating the fourth transaction receipt based on the crediting and debiting of the fourth rebate amount. Further, the storage device 1306 may be configured for storing the fourth transaction receipt in the distributed ledger.

FIG. 14 illustrates a block diagram of the system 1300 of provisioning a rebate based on purchasing, in accordance with some embodiments.

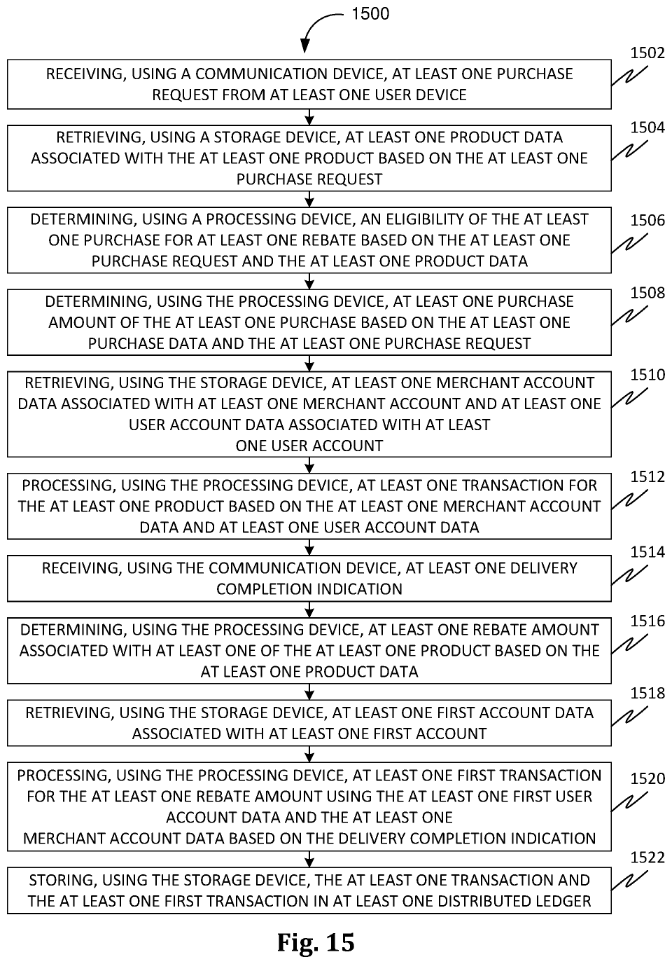

FIG. 15 is a flowchart of a method 1500 for facilitating provisioning rebates based on purchasing, in accordance with some embodiments. Accordingly, at 1502, the method 1500 may include a step of receiving, using a communication device (such as the communication device 1302), at least one purchase request from at least one user device associated with at least one user. Further, the at least one purchase request may be associated with at least one purchase of the at least one product from at least one merchant. Further, the at least one purchase request may include a delivery mode indication corresponding to a mode of delivery of the at least one product and at least one product identifier of the at least one product. Further, the mode of delivery may include a home delivery, a curbside pickup, etc. Further, the at least one product identifier may include a name of product, a type of product, etc. Further, the at least one user may include an individual, an institution, and an organization that wants to purchase the at least one product from the at least one merchant. Further, the at least one user device may include a smartphone, a laptop, a tablet, a desktop, a smartwatch, etc. Further, at 1504, the method 1500 may include a step of retrieving, using a storage device (such as the storage device 1306), at least one product data associated with the at least one product based on the at least one purchase request. Further, at 1506, the method 1500 may include a step of determining, using a processing device (such as the processing device 1304), an eligibility of the at least one purchase for at least one rebate based on the at least one purchase request and the at least one product data. Further, at 1508, the method 1500 may include a step of determining, using the processing device, at least one purchase amount of the at least one purchase based on the at least one purchase data and the at least one purchase request. Further, at 1510, the method 1500 may include a step of retrieving, using the storage device, at least one merchant account data associated with at least one merchant account and at least one user account data associated with at least one user account. Further, the at least one merchant account may be associated with the at least one merchant. Further, the at least one user account may be associated with the at least one user. Further, at 1512, the method 1500 may include a step of processing, using the processing device, at least one transaction for the at least one product based on the at least one merchant account data and at least one user account data. Further, in an embodiment, the at least one transaction may include crediting the at least one merchant account with the at least one purchase amount by debiting at least one user account with the at least one purchase amount of the at least one purchase. Further, at 1514, the method 1500 may include a step of receiving, using the communication device, at least one delivery completion indication associated with a completion of a delivery of the at least one product from at least one courier device. Further, the at least one courier device associated with at least one courier. Further, the at least one courier may deliver the at least one product associated with at least one user. Further, the at least one courier device may include a second smartphone, a second laptop, a second tablet, a second desktop, a second smartwatch, etc. Further, at 1516, the method 1500 may include a step of determining, using the processing device, at least one rebate amount associated with at least one of the at least one product based on the at least one product data. Further, at 1518, the method 1500 may include a step of retrieving, using the storage device, at least one first account data associated with at least one first account. Further, the at least one first account may be associated with the at least one user. Further, the at least one first account may be managed by the at least one merchant. Further, at 1520, the method 1500 may include a step of processing, using the processing device, at least one first transaction for the at least one rebate amount using the at least one first user account data and the at least one merchant account data based on the delivery completion indication. Further, the at least one first transaction may include crediting the at least one first user account with the at least one rebate amount by debiting the at least one merchant account with the at least one rebate amount. Further, at 1522, the method 1500 may include a step of storing, using the storage device, the at least one transaction and the at least one first transaction in at least one distributed ledger. Further, in some embodiments, the at least one transaction may include crediting the at least one merchant account with the at least one purchase amount by debiting the at least one purchase amount from at least one rebate amount accumulated in the at least one first user account.

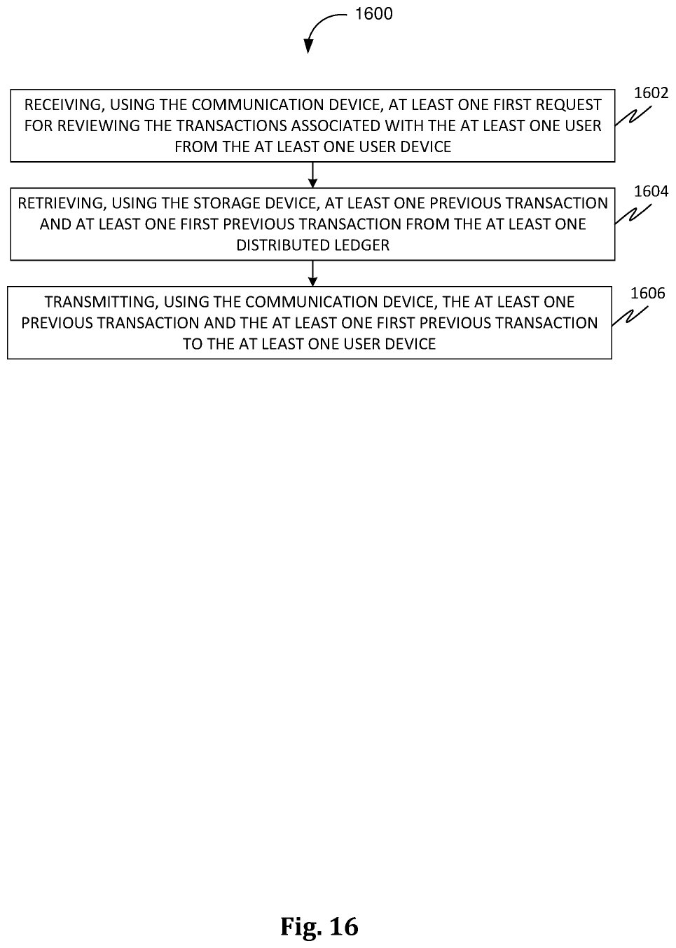

FIG. 16 is a flowchart of a method 1600 for facilitating transmitting transactions associated with the at least one user, in accordance with some embodiments. Accordingly, at 1602, the method 1600 may include a step of receiving, using the communication device, at least one first request for reviewing the transactions associated with the at least one user from the at least one user device. Further, at 1604, the method 1600 may include a step of retrieving, using the storage device, at least one previous transaction and at least one first previous transaction from the at least one distributed ledger. Further, at 1606, the method 1600 may include a step of transmitting, using the communication device, the at least one previous transaction and the at least one first previous transaction to the at least one user device.

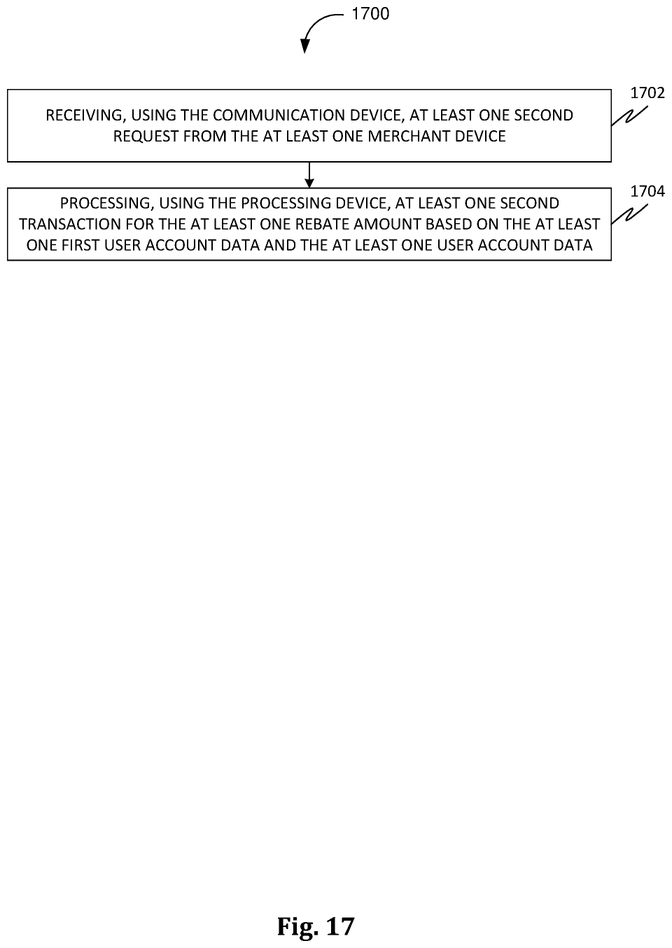

FIG. 17 is a flowchart of a method 1700 facilitating transferring rebate amount to the at least one user, in accordance with some embodiments. Accordingly, at 1702, the method 1700 may include a step of receiving, using the communication device, at least one second request from the at least one merchant device.

Further, at 1704, the method 1700 may include a step of processing, using the processing device, at least one second transaction for the at least one rebate amount based on the at least one first user account data and the at least one user account data.

Further, in an embodiment, the at least one second transaction may include crediting the at least one user account with the at least one rebate amount by debiting the at least one first user account with the at least one rebate amount. Further, the at least one second transaction may include a wire transfer.

Further, in some embodiments, the processing of the at least one second transaction may include generating at least one digital check of the at least one rebate amount based on the at least one user account data and the at least one first user account data. Further, the method 1700 may include a step of transmitting, using the communication device, the at least one digital check to at least one printing device. Further, the at least one printing device may be configured for printing at least one physical check based on the at least one digital check. Further, the at least one digital check may be mailed to the at least one user.

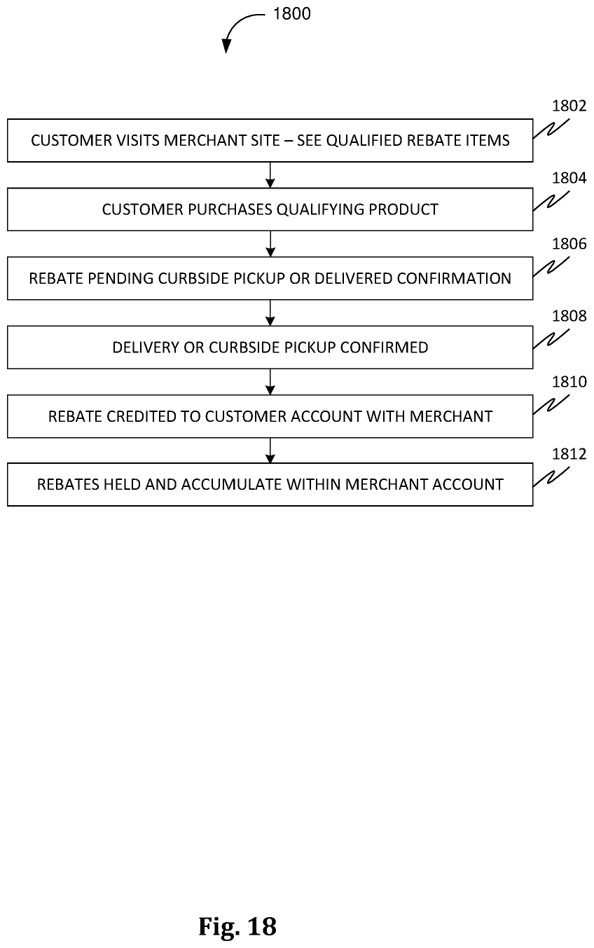

FIG. 18 is a flowchart of a method 1800 for facilitating accumulating rebates with purchases, in accordance with some embodiments. Accordingly, at 1802, the method 1800 may include a step of a customer visiting a merchant site to see qualifying rebate items.

Further, at 1804, the method 1800 may include a step of the customer purchasing a qualifying product.

Further, at 1806, the method 1800 may include a step of pending rebate for the curbside pickup and delivered confirmation.

Further, at 1808, the method 1800 may include a step of confirming the delivery or curbside pickup.

Further, at 1810, the method 1800 may include a step of crediting the rebate to a customer account.

Further, at 1812, the method 1800 may include a step of accumulating and holding the rebates within a merchant account.

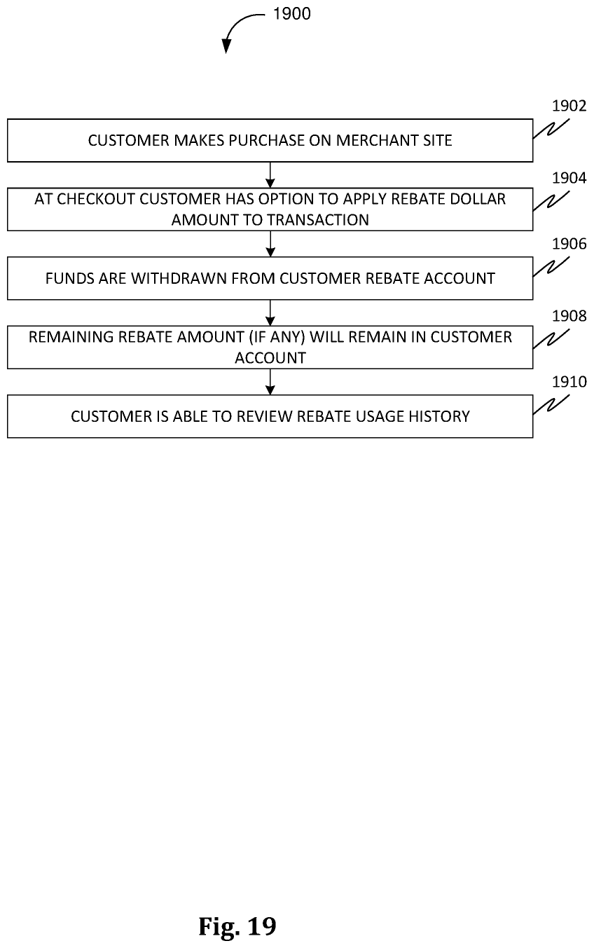

FIG. 19 is a flowchart of a method 1900 for facilitating applying the rebate for purchasing, in accordance with some embodiments. Accordingly, at 1902, the method 1900 may include a step of a customer making a purchase on a merchant site.

Further, at 1904, the method 1900 may include a step of providing the customer with an option to apply a rebate amount to the transaction at checkout.

Further, at 1906, the method 1900 may include a step of withdrawing funds from the rebate account of the customer.

Further, at 1908, the method 1900 may include leaving the remaining rebate amount (if any) in the customer account after the withdrawal.

Further, at 1910, the method 1900 may include a step of allowing the customer to review a usage history of the rebate.

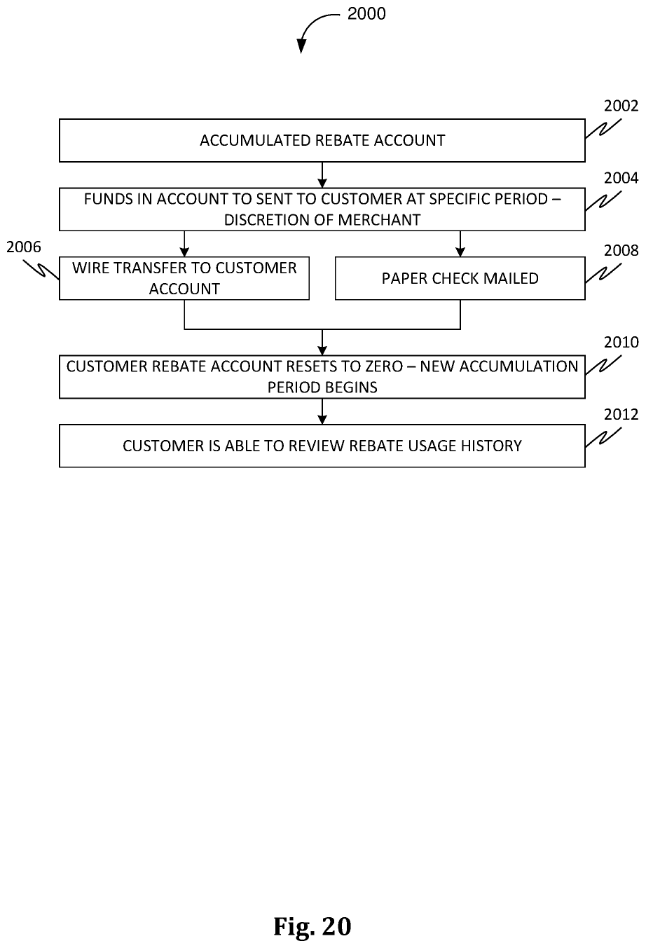

FIG. 20 is a flowchart of a method 2000 for facilitating transferring rebate funds to the customer, in accordance with some embodiments.

Accordingly, at 2002, the method 2000 may include a step of accessing an accumulated rebate amount in the rebate account.

Further, at 2004, the method 2000 may include a step of sending funds in the rebate account to the customer at a specific period or at the discretion of the merchant.

Further, at 2006, the method 2000 may include a step of transferring the funds to the customer account using a bank wire.

Further, at 2010, the method 2000 may include a step of resetting the rebate account of the customer to zero and beginning a new accumulation period.

Further, at 2012, the method 2000 may include a step of allowing the customer to review the usage history of the rebate.

Further, after 2004, at 2008, the method 2000 may include a step of mailing a paper check to the customer. Further, after 2008, the method 2000 may proceed to the step at 2010.

Although the invention has been explained in relation to its preferred embodiment, it is to be understood that many other possible modifications and variations can be made without departing from the spirit and scope of the invention as hereinafter claimed.

We claim:

1. A method of provisioning a rebate based on purchasing, the method comprising:
receiving, using a communication device, a transaction information from a merchant device associated with a merchant, wherein the transaction information comprises a user information associated with a user and a delivery mode information associated with a purchase request corresponding to a product;
identifying, using a processing device, a user account associated with the user based on the user information;
crediting, using the processing device, a rebate amount to the user account based on the identifying and the delivery mode information, wherein the user account is stored on a distributed ledger; and
storing, using a storage device, the rebate amount in the distributed ledger.

2. The method of claim 1, wherein the method further comprises receiving, using the communication device, a confirmation information from the merchant device, wherein the confirmation information indicates receipt of the product according to the delivery mode information, wherein the crediting is further based on the confirmation information.

3. The method of claim 1, wherein the method further comprises:
receiving, using the communication device, a first transaction request information from the merchant device, wherein the first transaction request information comprises a first purchase request and a request for using the rebate amount in the first purchase request;
debiting, using the processing device, a first rebate amount based on the first transaction request information from the user account;
generating, using the processing device, a transaction receipt based on the first rebate amount and the rebate amount;
storing, using the storage device, the transaction receipt in the distributed ledger; and
transmitting, using the communication device, the transaction receipt to the merchant device.

4. The method of claim 3, wherein the method further comprises:
receiving, using the communication device, a second transaction request information from the merchant device, wherein the second transaction request information comprises a request for transferring a second rebate amount to a bank account associated with the user;
initiating, using the processing device, a money transfer request based on the second transaction request information;
generating, using the processing device, a first transaction receipt based on the second rebate amount and the rebate amount; and
storing, using the storage device, the first transaction receipt in the distributed ledger.

5. The method of claim 3, wherein the method further comprises:
generating, using the processing device, a digital cheque based on the second transaction request information; and
transmitting, using the communication device, the digital cheque to a printing device associated with the merchant, wherein the printing device is configured for printing.

6. The method of claim 1, wherein the method further comprises:
receiving, using the communication device, a merchant information from the merchant device, wherein the merchant information comprises a rebate policy information associated with the user account;
generating, using the processing device, a merchant account information based on the merchant information; and
storing, using the storage device, the merchant account information in the distributed ledger.

7. The method of claim 1, wherein the method further comprises:
receiving, using the communication device, a request information for reviewing a previous transaction information associated with each of the user account and the merchant from the merchant device;
retrieving, using the storage device, the previous transaction information based on the request information from the distributed ledger;
generating, using the processing device, a mini statement information based on the previous transaction information; and
transmitting, using the communication device, the mini statement information to the merchant device.

8. The method of claim 1, wherein the method further comprises:
receiving, using the communication device, a transaction history information associated with the user from the merchant device;
analyzing, using the processing device, the transaction history information using a machine learning model;
generating, using the processing device, an optimal rebate policy information based on the analyzing of the transaction history information, wherein the user account is managed in accordance with the optimal rebate policy information;
transmitting, using the communication device, the optimal rebate policy information to the merchant device;
receiving, using the communication device, a confirmation from the merchant device, wherein the confirmation is associated with the optimal rebate policy information; and
storing, using the storage device, the optimal rebate policy information in association with each of a merchant account and the user account, wherein the optimal rebate policy information is stored in the distributed ledger.

9. The method of claim 8, wherein the method further comprises:
debiting, using the processing device, a third rebate amount from the user account based on the expiry date information;
initiating, using the processing device, a first bank amount transfer request based on the debiting of the third rebate amount to a merchant bank account associated with the merchant;
generating, using the processing device, a second transaction receipt based on the debiting of the third rebate amount;
generating, using the processing device, a third transaction receipt based on the initiating of the first bank amount transfer request;
storing, using the storage device, the second transaction receipt and the third transaction receipt in the distributed ledger; and
transmitting, using the communication device, the third transaction receipt to the merchant device.

10. The method of claim 1, wherein the method further comprises:
receiving, using the communication device, a transfer request from the merchant device, wherein the transfer request comprises a request for transferring a fourth rebate amount from the user account to another user account;
debiting, using the processing device, the fourth rebate amount from the user account based on the transfer request;
crediting, using the processing device, the fourth rebate amount to the another user account associated with another user;
generating, using the processing device, a fourth transaction receipt based on the crediting and debiting of the fourth rebate amount;
storing, using the storage device, the fourth transaction receipt in the distributed ledger; and
transmitting, using the communication device, the fourth transaction receipt to the merchant device.

11. A system of provisioning a rebate based on purchasing, wherein the system comprises:
a communication device configured for receiving a transaction information from a merchant device associated with a merchant, wherein the transaction information comprises a user information associated with a user and a delivery mode information associated with a purchase request corresponding to a product;
a processing device configured for:
identifying a user account associated with the user based on the user information, wherein the user account is stored on a distributed ledger; and
crediting a rebate amount to the user account based on the identifying and the delivery mode information; and
a storage device configured for storing the rebate amount in the distributed ledger.

12. The system of claim 11, wherein the communication device is further configured for:
receiving a first transaction request information from the merchant device, wherein the first transaction request information comprises a first purchase request and a request for using the rebate amount in the first purchase request;
transmitting, using the communication device, a transaction receipt to the merchant device, wherein the processing device is further configured for:
debiting a first rebate amount based on the first transaction request information from the user account; and
generating the transaction receipt based on the first rebate amount and the rebate amount, wherein the storage device is further configured for storing the transaction receipt in the distributed ledger.

13. The system of claim 12, wherein the communication device is further configured for receiving a second transaction request information from the merchant device, wherein the second transaction request information comprises a request for transferring a second rebate amount to a bank account associated with the user, wherein the processing device is further configured for:
initiating a money transfer request based on the second transaction request information; and
generating a first transaction receipt based on the second rebate amount and the rebate amount, wherein the storage device is further configured for storing the first transaction receipt in the distributed ledger.

14. The method of claim of claim 13, wherein the communication device is further configured for transmitting a digital cheque to a printing device associated with the merchant, wherein the printing device is configured for printing, wherein the processing device is further configured for generating the digital cheque based on the second transaction request information.

15. The system of claim 11, wherein the communication device is further configured for receiving a merchant information from the merchant device, wherein the merchant information comprises a rebate policy information associated with the user account, wherein the processing device is further configured for generating a merchant account information based on the merchant information, wherein the storing device is further configured for storing the merchant account information in the distributed ledger.

16. The system of claim 11, wherein the communication device is further configured for:
receiving a request information for reviewing a previous transaction information associated with each of the user account and the merchant from the merchant device; and
transmitting a mini statement information to the merchant device, wherein the storage device is further configured for retrieving the previous transaction information based on the request information for reviewing the previous transaction information associated with the user account from the distributed ledger, wherein the processing device is further configured for generating the mini statement information based on the previous transaction information.

17. The system of claim 11, wherein the communication device is further configured for:
receiving a transaction history information associated with the user from the merchant device;
transmitting an optimal rebate policy information to the merchant device; and
receiving a confirmation from the merchant device, wherein the confirmation is associated with the optimal rebate policy information, wherein the processing device is further configured for:
analyzing the transaction history information using a machine learning model; and
generating the optimal rebate policy information based on the analyzing of the transaction history information, wherein the user account is managed in accordance with the optimal rebate policy information, wherein the storage device is further configured for storing the optimal rebate policy information in association with each of a merchant account and the user account, wherein the optimal rebate policy information is stored in the distributed ledger.

18. The system of claim 12, wherein the processing device is further configured for generating an expiry date information based on the crediting of the rebate amount, wherein the storage device is further configured for storing the expiry date information in the distributed ledger, wherein the debiting is further based on the expiry date information.

19. The system of claim 18, wherein the communication device is further configured for transmitting a third transaction receipt to the merchant device, wherein the processing device is further configured for:
debiting a third rebate amount from the user account based on the expiry date information;
initiating a first bank amount transfer request based on the debiting of the third rebate amount to a merchant bank account associated with the merchant;
generating a second transaction receipt based on the debiting of the third rebate amount; and
generating the third transaction receipt based on the initiating of the first bank amount transfer request, wherein the storage device is further configured for storing the second transaction receipt and the third transaction receipt in the distributed ledger.

20. The system of claim 11, wherein the communication device is further configured for:
receiving a transfer request from the merchant device, wherein the transfer request comprises a request for transferring a fourth rebate amount from the user account to another user account; and
transmitting a fourth transaction receipt to the merchant device, wherein the processing device is further configured for:
debiting the fourth rebate amount from the user account based on the transfer request;
crediting the fourth rebate amount to the another user account associated with another user; and
generating the fourth transaction receipt based on the crediting and debiting of the fourth rebate amount, wherein the storage device is further configured for storing the fourth transaction receipt in the distributed ledger.
